(19) United States
(12) Patent Application Publication
(10) Pub. No.: US 2003/0107884 A1
(43) Pub. Date: Jun. 12, 2003

(54) Flat illuminator with flexible integral switching arm

(76) Inventors: Mark Howard Krietzman, Palos Verdes Estates, CA (US); Yu-Hsin Chen, Palos Verdes Estates, CA (US)

Correspondence Address: MARK KRIETZMAN, P.O. BOX 3185, PALOS VERDES, CA, 90274, US

(21) Appl. No.: 10/238,265

(22) Filed: Sep. 10, 2002

Related U.S. Application Data
(63) Continuation-in-part of application No. 09/740,472, filed on Dec. 19, 2000, now Pat. No. 6,447,143.
(60) Provisional application No. 60/172,985, filed on Dec. 20, 1999.
(60) Provisional application No. 60/202,894, filed on May 10, 2000.
(60) Provisional application No. 60/253,188, filed on Nov. 27, 2000.
(60) Provisional application No. 60/330,366, filed on Oct. 22, 2001.

(51) Int. Cl. F21L 4/00

(52) U.S. Cl. 362/189; 362/200

(57) ABSTRACT

A flat illuminator with a flexible switching arm that connects a battery power supply to an LED illumination source. Multi-layered construction combined with conductive inks, wires or foils are used to link the battery and LED illumination source while maintaining a thin credit card-like profile.

### 1. RELATED APPLICATIONS

The invention is a continuation-in-part of Applicants application Ser. No. 09/740,472 entitled FLAT CREDIT CARD ILLUMINATOR WITH FLEXIBLE INTEGRAL SWITCHING ARM now U.S. Pat. No. ______ which claimed the benefit of Provisional Application Nos. 60/172,985, 60/202,894, and 60/253,188. And which now claims the benefit, under Title 35, United States Code 119 (e), of Provisional Application No. 60/330,366, filed Oct. 22, 2001, entitled MULTI-LAYERED FLAT ILLUMINATOR all of which are hereby incorporated by this reference.

### BACKGROUND OF THE INVENTION

1. Field of the Invention

This present invention relates to a thin flat illuminator. More particularly to a plastic card-like light which illuminates with one or more light-emitting diodes “LEDs” and is switched on/off with a flexible switching arm.

2. Related Arts

A recent card light found in U.S. Pat. No. 6,070,990 assigned to the Eveready Battery Company illustrates how a single button battery may be sandwiched between the anode and cathode of a circular LED integrated into a switching mechanism. The circular LED protrudes beyond the top and bottom edges of the card light encasement. It is switched with a pressure switch activated by pressing on a top or bottom body surface.

Another planar flashlight is found in U.S. Pat. No. 5,934,789, issued to Sinclair et. al., which teaches a large relatively planar disposable flashlight. The Sinclair flashlight uses is the size of a deck of playing card and will not fit in the credit card slot of a wallet. It is switched with a pressure switch activated by pressing on a top or bottom body surface.

Card-like illuminators with pressure switches activated by pressing on a top or bottom surface may be inadvertently switched on when stored in a wallet. It would therefore be desirous to have a credit-card like illuminator with an on/off switch not activated by pressure on a top or bottom surface.

### SUMMARY OF INVENTION

The invention herein is a flat card-like flashlight or illuminator with a horizontal “on/off” switch formed by a flexible switching arm extending in plane with the flat card-like body. Actuation of the illuminator is through the movement of the flexible switching arm in plane with the card-like body.

The card-like illuminator may be disposable with the battery supply fixed within the body (FIGS. 1 & 2) or the illuminator may have replaceable batteries with a slot, panel or door allowing access to the battery supply (FIGS. 4,6 & 7). The “on./off” switch may also latch (FIGS. 5 & 7) for a constant on mode. Within the scope of the invention is the use of multiple light emitting diodes “LEDs” and a variety of battery configurations. Promotional, advertising and/or information may be stenciled onto or otherwise placed on the card-like light. Magnets may be incorporated into the body for mounting or hands free operation. The features of the invention believed to be novel are set forth with particularity in the appended claim. The invention itself, however, both as to configuration, and method of operation, and the advantages thereof, may be best understood by reference to the following specification, abstract, claims and accompanying drawings.

### BRIEF DESCRIPTION OF THE DRAWINGS

FIG. 1A is a top view of the preferred embodiment of the flat card light.

FIG. 1B is a side view of the preferred embodiment.

FIG. 1C is a rear view of the preferred embodiment.

FIG. 1D is a front view of the preferred embodiment.

FIG. 2 is a top view of a first alternate embodiment of the flat card light.

FIG. 3A is a top view of an uncovered second alternate embodiment of the flat card light.

FIG. 3B is a top view of the cover for the embodiment of FIG. 3A.

FIG. 4 is a top view of a third alternate embodiment of the flat card light.

FIG. 5A is a perspective view of a first latching switch for the flat card light in the off position.

FIG. 5B is a perspective view of the latching of FIG. 5A in the on position.

FIG. 6 is a perspective view of a fourth alternate embodiment of the flat card light.

FIG. 7A is a top perspective view of a fifth alternate embodiment of the flat card light.

FIG. 7B is a bottom perspective view of the embodiment of FIG. 7A.

FIG. 7C is a close-up view of the embodiment of FIG. 7A showing a second embodiment of a latching switch.

FIG. 7D is a close-up view of the embodiment of FIG. 7C in the momentary on position.

FIG. 7E is a close-up view of the embodiment of FIG. 7C in the latched on position.

FIG. 8A is an assembly view of a first embodiment of the card light.

FIG. 8B is a top view of the embodiment on FIG. 8A.

FIG. 8C is a partial view of the switching arm of the embodiment ion FIG. 8A.

### DETAILED DESCRIPTIONS OF THE PREFERRED EMBODIMENTS

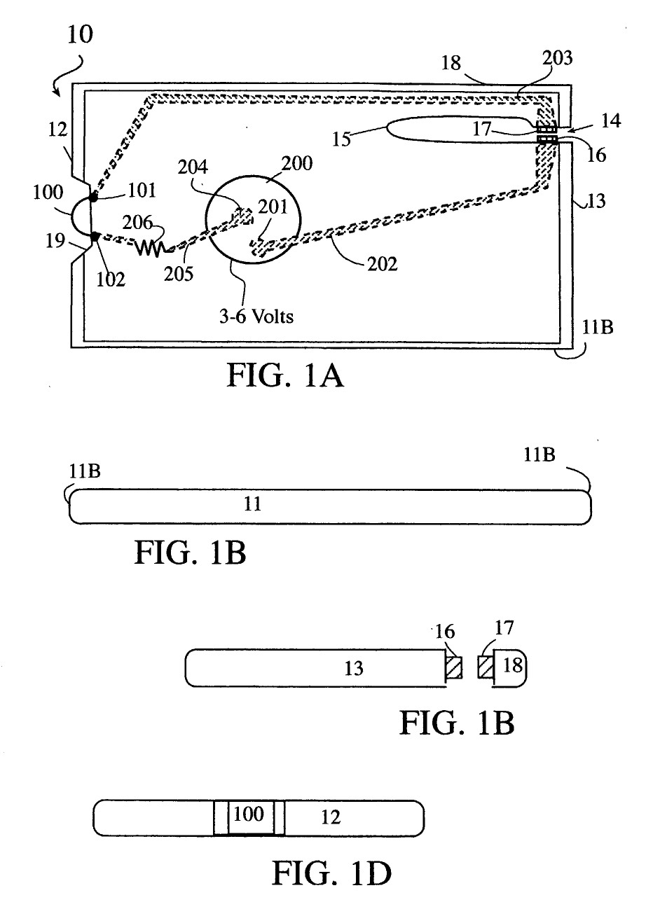

Illustrated in FIGS. 1A,1B, 1C and 1D, are top, front, rear and side views of the preferred embodiment of the flat card light generally designated 10 and constructed on a planar plastic body 11A with an edge thickness between about 1.0 mm and about 3.5 mm, tapered or beveled around some or all of the periphery 11B and shaped to fit within the credit card slot of a wallet and has a front edge 12 and a back edge 13. Formed integrally in the back edge 13 is a horizontal pressure switch 14.

The horizontal pressure switch 14 lays flat and does not exceed the thickness of the plastic body 11A. A switch guide 15 is formed, or die-cut, in a portion of the plastic body 11A and the periphery 11B, forming a flexible switching arm 18, of the horizontal pressure switch 14, which extends from the plastic body 11A. A first switch contact 16 is affixed to the flexible switching arm 18 and a second switch contact 17 is affixed on opposite side of the switch guide 15. The flexible switching arm 18 is sufficiently flexible whereby the first switching contact 16 may be placed into contact with the second switching contact 17 by momentarily displacing the flexible switching arm 18. The first and second switching contacts 16 and 17 are formed of a metallic material suitable for conducting electricity such as tin, steel, iron, copper, brass, or titanium. A light well 19 may also be formed in the front edge 12 wherein a LED 100 is affixed.

Light-emitting diodes (LEDs) 100 are common in industry and no specific LED is called out for, and any low profile LED which produces an output in the visible spectrum is contemplated. LEDs typically have an anode and a cathode lead wire. Suitable LEDs include, but are not limited to, the HLMA-QH00-UW011 Subminiature High Performance AllnGAP LED lamps manufactured by Agilent Technologies, or one of the KM2520xxx001, 002 or 003 Subminiature Solid State Led Lamps, manufactured by King Bright. A flat LED, similar to the HSMx-C1110/170/190/C191 High Performance ChipLED manufactured by Agilent Technologies, Inc., or the ESM-3070 series LED, manufactured by Elekon Industries, in Torrance, Calif., or an oval shaped LED such as the IHD 2651 or the IGD 2651 2×3 mm Oblong manufactured by IDEA, Inc., in Brea Calif. may also be used. The indication of a circular, oblong or flat LED is not intended as a limitation on the scope of the invention, and the choice of LED will be a function of the battery supply and intended usage. In prototype LEDs have been constructed from, Nichia ultra bright 3 LEDs, wherein the epoxy casing was machined down on two sides by approximately 0.5 mm to a flat configuration of about 2 mms×3 mms.

Suitable battery supplies include, in each stack, one or more button battery such as the Poly-carbonmonofluoride (BR series) lithium batteries or the Manganese dioxide (CR series) lithium batteries either with a height, preferably of 3 mm or less, manufactured by Matsushita Electric Corporation of America (Panasonic). The above examples of button batteries are not an exhaustive list of possible power supplies, nor is the above list intended to act as a limitation on the doctrine of equivalents.

The power supply for the flat illuminator shown in this embodiment is a button type lithium battery 200 CR 2016, or CR 2405, both manufactured by Matsushita Electric Corporation of America (Panasonic). In this embodiment a stacked pair of CR 2405 batteries yield a nominal voltage of 6 volts with a current of 28 milliamperes. A first battery contact 201 placed against the negative terminal of the battery is conductively linked to the first switch contact 16 by a first conductive strip 202. A second conductive strip 203 is attached to the second switch contact 17 at one end and to a first LED contact 101 of the LED 100 at its other end. The second LED contact 102 is attached to the a battery's positive terminal at the second battery contact 204 via a third contact strip 205.

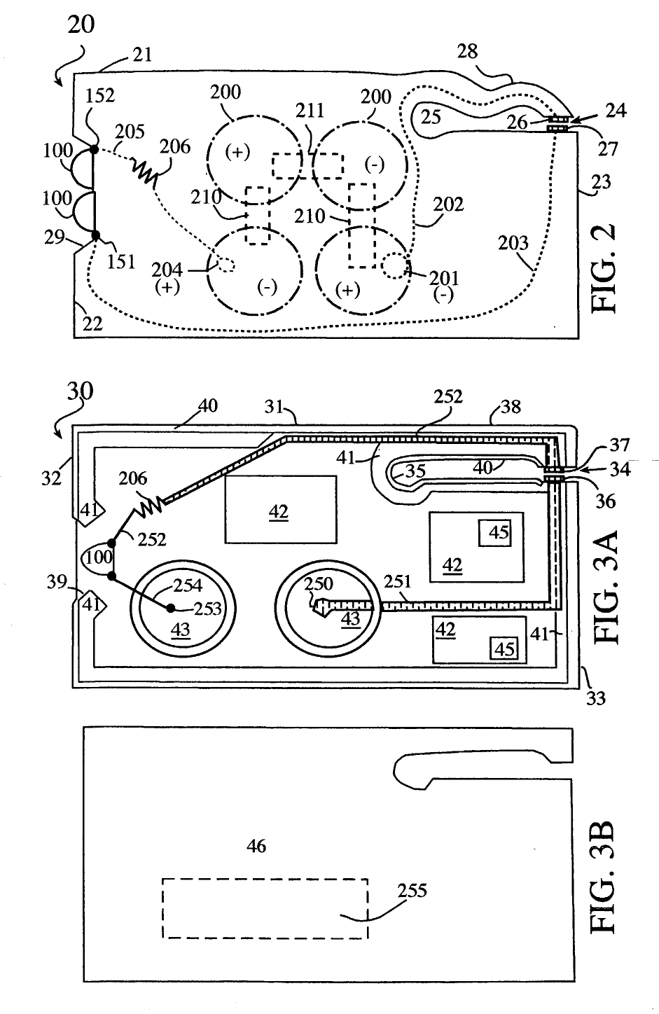

As noted above a pair CR 2016 battery may be used in place of the pair of CR 2405 batteries, however due to the thickness of the CR 2016 batteries the pair should be placed side by side within the casing as shown in FIG. 2. The CR 2016 battery yield a nominal forward current 90 milliamperes. A 90 milliamperes forward current may exceed the maximum 60 milliamperes forward current of the ESM-3070 LED 100, therefore a resistor 206 should be integrated into the third contact strip to limit the current.

Illustrated in FIG. 2 is a first alternate embodiment of the flat card light generally designated 20. The flat card light is constructed of a planar plastic body 21 with an edge thickness between about 1.0 mm and about 3.5 mm and shaped to fit within the credit card slot of a wallet and has a front edge 22 and a back edge 23. A horizontal pressure switch 24 is formed integrally in the planar plastic body. The horizontal pressure switch 24 lays flat and does not exceed the thickness of the plastic body 21. A switch guide 25 is formed, or die-cut, in a portion of the plastic body 21 thereby forming a flexible shaped switching arm 28 which extends from the plastic body 21. A first switch contact 26 and a second switch contact 27 are affixed on opposite side of the switch guide 25. The first switch contact 26 being affixed to the shaped switching arm 28. The shaped switching arm 28 is sufficiently flexible along its length whereby the shaped switching arm 28, with the first switch contact 26 thereon, may be momentarily displaced to bring the first switch contact 26 into contact with the second switching contact 27 thereby powering the LED array 150. A light guide 29 may be formed on the front edge 22 wherein the LED array 150 is affixed.

The power supply for the light is a group of button type lithium battery 200. In this first alternate embodiment four CR 2016 batteries with a combined nominal voltage of 12 volts with a current of 90 milliamperes are connected in series via a pair of upper contact strips 210 and a lower contact strip 211. To power the LED array 150 a first battery contact 201 is placed against the negative terminal of the battery and conductively linked to the first switch contact 26 by a first conductive strip 202. A second conductive strip 203 is attached to the second switch contact 27 at one end and to a first LED array contact 151 at its other end. The second LED array contact 152 is attached to the a battery's positive terminal at the second battery contact 204 via a third contact strip 205 a resistor 206 may be integrated into the third contact strip 205 to limit the current to the LED array 150.

Shown in FIGS. 3A and 3B are the body cavity and cover of a second alternate embodiment of the flat card light generally designated 30 and constructed within a plastic cavity body 31 with an edge thickness between about 1.0 mm and about 3.5 mm and shaped to fit within the credit card slot of a wallet. The plastic cavity body 31 has a front edge 32 and a back edge 33, with a flexible pressure switch 34 integrally formed therein. The flexible pressure switch 34 lays flat and does not exceed the thickness of the body 31. A switch guide 35 is formed, or die-cut, in a portion of the plastic cavity body 31 providing a switching arm 38 extending from the plastic cavity body 31. A first switch contact 36 and a second switch contact 37 are affixed on opposite side of the switch guide 35. The switching arm 38 is sufficiently flexible, along its length, whereby the switching arm 38, with the first switch contact 36 thereon, may be momentarily displaced to bring the first switch contact 36 into contact with the second switching contact 37 thereby powering the LED 100. A light guide 39 may be formed on the front edge 32 where the LED 100 is affixed.

Forming the thickest portion of the plastic cavity body 31 is a raised edge 40 which substantially surrounds the plastic cavity body 31, adjacent to substantially all of the raised edge 40, and inside the plastic body 31, is a inset shelf 41 of a height whereby a supported cover will be aligned with the raised edge 40. Also within the plastic cavity body 31 are several cover supports 42 of a height whereby a supported cover will be aligned with the raised edge 40. Battery wells 43 are formed by a surrounding well walls 44 of a height whereby a supported cover will be aligned with the raised edge 40. A group of magnets 45 may also be affixed through the plastic cavity body 31. A cover 46 of a size and shape to mate with the plastic cavity body 31 is used to cover the plastic cavity body 31.

The power supply for the LED 100 is a pair of button type lithium battery (not shown) which are placed in the battery wells 43. A first battery contact 250 rests against the negative terminal of the battery, which is conductively linked to the first switch contact 36 by a first conductive strip 251. A second conductive strip 252 is attached to the second switch contact 37 at one end and to a first LED contact 101 at its other end. The second LED contact 102 is attached to the battery's positive terminal at the second battery contact 253 via a third contact strip 254. A resistor 206 may be integrated into the second contact strip 252 to limit the current to the LED 100. To serially connect the batteries (not shown) they are placed into the battery wells 43 and a cover contact 255 is affixed to the inside face of the cover 46 adapted to engage the top terminal of each battery 200 in each well 43.

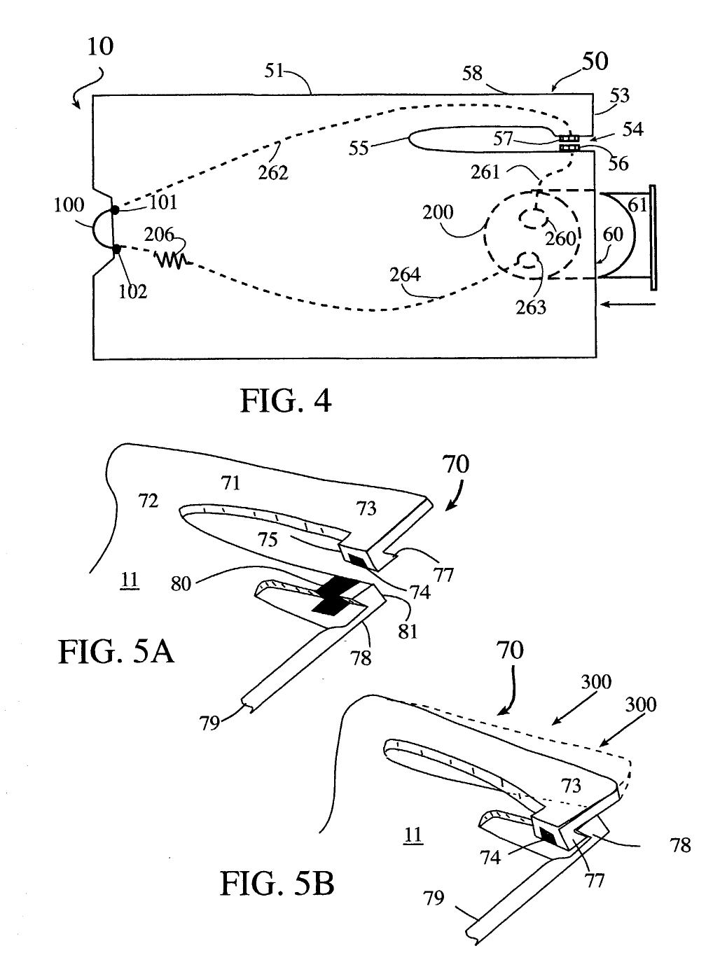

Shown in FIG. 4 is a third alternate embodiment of the flat card light generally designated 50 which is constructed around a planar plastic body 51 with a thickness between about 1.0 mm and about 3.5 mm and shaped to fit within the credit card slot of a wallet. The plastic body 51 has a front edge 52, a back edge 53, and a horizontal pressure switch 54 formed integrally in the back edge 53. The horizontal pressure switch 54 lays flat and does not exceed the thickness of the plastic body 51. A switch guide 55 is formed, or die-cut in, through a portion of the plastic body 51 providing a flexible switching arm 58 extending from the plastic body 51. A first switch contact 56 and a second switch contact 57 are affixed on opposite side of the switch guide 55. The flexible switching arm 58 is sufficiently flexible, along its length, whereby the switching arm 58, with the first switch contact 56 thereon, may be momentarily displaced to bring the first switch contact 56 into contact with the second switching contact 57 thereby powering the LED 100.

The power supply for the light is a button type lithium battery 200 such as a pair of CR 2405, manufactured by Matsushita Electric Corporation of America (Panasonic) with a combined nominal voltage of 6 volts at 28 milliamperes stacked together with a first battery contact 260 against the negative terminal of the battery 200 and conductively linked to the first switch contact 56 by a first conductive strip 261. A second conductive strip 262 is attached to the second switch contact 57 at one end and to a first LED contact 101 at its other end. The second LED contact 102 is attached to the a batterys' positive terminal at the second battery contact 263 via a third contact strip 264. A resistor 206 may be integrated into the third contact strip 264 to limit the current to the LED 100.

The battery in this configuration is replaceable and is seated in a battery chamber 59 formed within the plastic body 51 with an entry way 60 at the back edge 53 and a removably door 61 of a size and shape to removably mate with the entry way 60.

The card light may be operated through the momentary engagement of the switch contacts 56 and 57 via the horizontal movement of the pressure switch (FIGS. 1-4) or the pressure switch may be shaped to yield a latching function thereby allowing a fixed on mode until such latched switch is unlatched. Shown in FIGS. 5A and 5B is a perspective view of a first embodiment of a latching switch in the on and the off positions, generally designated 70. The flexible switching arm 71 at one end 72 extends substantially in plane from the plastic body 11 of a flat card light and has a free end 73. A first switch contact 74 is affixed both to the first momentary face 75 and the underside 76 of the free end 73, a latching hook 77 is also formed on the underside 76 of the free end 73 adjacent to the first switch contact 74. The latching hook 77 fits into a corresponding switch catch 78 formed on the edge 79 of the plastic body 11 opposite the latching hook 77 and connects to second switch contact 80 to the first switch contact 74 (FIG. 5B) thereby switching the flat illuminator on. The second switch contact 80 covers a portion of the second momentary face 81. By contacting the two momentary faces 75 & 81 together, via moving the flexible switching arm toward the switching catch 78 along the line of arrow 300 the circuit (shown in FIGS. 1-4, 6&7) may be closed and power supplied to an LED.

Shown in FIG. 5B is the placement of the latching hook 77 within the switch catch 78 which connects the first and second switch contacts 74 & 80 together thereby switching on the circuit and supplying current to the LED.

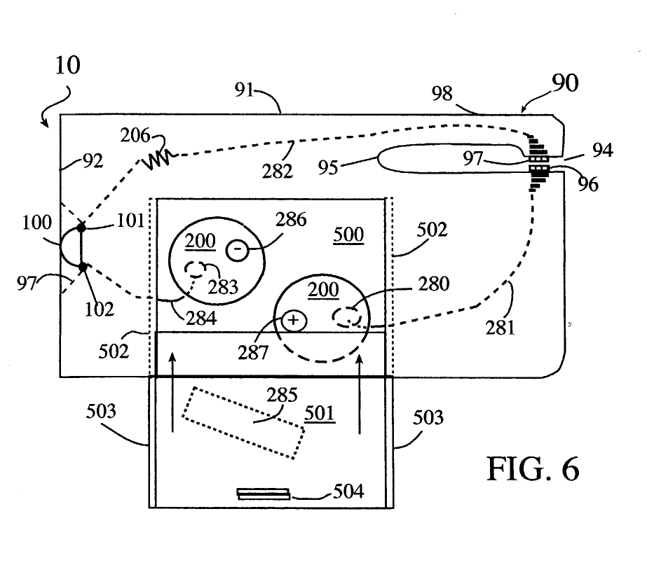

A fourth alternate embodiment of the flat card light 90 is shown in FIG. 6. The flat card light 90 is constructed around a planar plastic body 91 with a thickness between about 1.0 millimeters and about 3.5 millimeters and shaped to fit within the credit card slot of a wallet. The plastic body 91 has a front edge 92 and a back edge 93. A horizontal pressure switch 94 is formed integrally in the plastic body 91. The horizontal pressure switch 94 lays flat and does not exceed the thickness of the plastic body 91. A switch guide 95 is formed, or die-cut in, through a portion of the plastic body 91 providing a flexible switching arm 98 extending from the plastic body 91. A first switch contact 96 and a second switch contact 97 are affixed on opposite side of the switch guide 95. The flexible switching arm 98 is sufficiently flexible, whereby the switching arm 98, with the first switch contact 96 thereon, may be momentarily displaced to bring the first switch contact 96 into contact with the second switching contact 97 thereby powering the LED 100. A light well 99 is also be formed in the front edge 92 wherein a flat LED 100 is affixed.

The power supply is placed within a inset battery chamber 500 formed within the plastic body 91. The battery chamber is open at the edge of the plastic body 91 so that a sliding door 501, may be removably inserted to cover the battery chamber 500. Along two opposite edges of the battery chamber 500 are slide guides 502 into which fit the shaped edges 503 of the sliding door 501, a textured finger pad 504 is formed on the outside of the sliding door 501 to assist removal of the sliding door 501.

The power supply for the light is a pair of button type lithium battery 200 such as a CR 2016, or CR 2405, manufactured by Matsushita Electric Corporation of America (Panasonic). In this embodiment a pair of CR 2405 batteries with a combined nominal voltage of 6 volts, and a current of 28 milliamperes, are connected in series. A first battery contact 280 is placed against the negative terminal of the battery and conductively linked to the first switch contact 96 by a first conductive strip 281. A second conductive strip 282 is attached to the second switch contact 97 at one end and to a first LED contact 101 at its other end. The second LED contact 102 is attached to the a batterys' positive terminal at the second battery contact 283 via a third contact strip 284. To complete the connections a door contact 285 is affixed to the inside face of the sliding door whereby the top battery terminals 286 & 287 are connected.

A pair of CR 2016 batteries may be used in place of the pair of CR 2405 batteries, this will yield a combined nominal 6 volts and a current of 90 milliamperes. When using a the CR 2016 batteries, the current may exceed the forward current of the LED 100 and a resistor 206 should be integrated into the second contact strip 282 to limit the current.

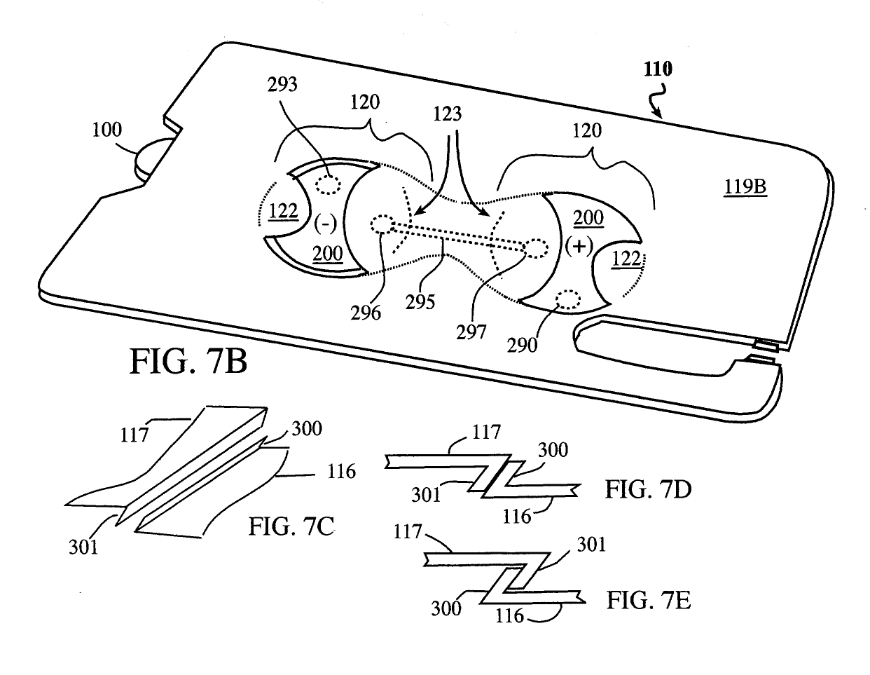

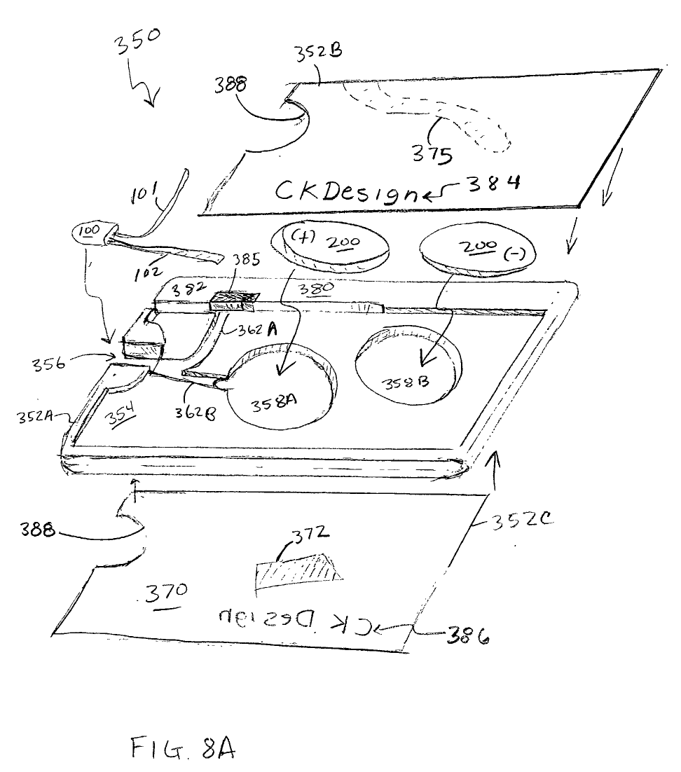

A fifth alternate embodiment of the flat card light, shown in FIGS. 7A-7E, generally designated 110, is constructed around a planar plastic body 111 of a thickness between about 1.0 millimeters and about 3.5 millimeters and shaped to fit within the credit card slot of a wallet. The plastic planar has a front edge 112 and a back edge 133. A dual function pressure switch 114 is formed integrally within the planar plastic body 111. A switch guide 115 is formed, or die-cut, in a portion of the plastic body 111 providing a flexible switching arm 118 extending from the plastic body 111. A first switch contact 116 and a second switch contact 117 are affixed on opposite side of the switch guide 115.

To switch on and off the LED 100 the flexible switching arm 118 is sufficiently flexible whereby the switching arm 118 with the first switch contact 116 thereon (FIG. 7C) may be displaced. For momentary activation of the LED 100, the angular contact edge 300 of the first switch contact 116 is moved by the displacement of the switching arm 118 against the angular contact edge 301 of the second switching contact 117 (FIG. 7D) thereby momentarily powering the LED 100. To latch the LED 100 on (FIG. 7E) the flexible switching arm 118 is displaced sufficiently to urge the angular contact edges 301 & 302 past each other, whereby when the displacement ceases the angular contact edges 300 & 301 catch each other.

Each battery 200 of the power supply is mounted through the top face 119A of the plastic body 111 within an inset battery holster 120. The battery holster has a top stirrup 121 an under footing 122 and a loading ramp 123. In FIG. 7B the mounted batteries 200 can be seen partially visible through the bottom face 119B resting above the under footing 122, and loading ramp 123 and under the stirrup 121.

The power supply for the light is a pair of button type lithium battery 200 such as a CR 2016, or CR 2405, manufactured by Matsushita Electric Corporation of America (Panasonic). A first battery contact 290 is held against the negative terminal of the battery and conductively linked to the first switch contact 116 by a first conductive strip 291. A second conductive strip 292 is attached to the second switch contact 117 at one end and to a first LED contact 101 at its other end. The second LED contact 102 is attached to the batterys' positive terminal at the second battery contact 293 via a third contact strip 294. To complete the connections a body contact 295 is affixed between the two loading ramps 123 with a first link contact 296 attaching the negative terminal of one battery 200 to the positive terminal of the other battery 200.

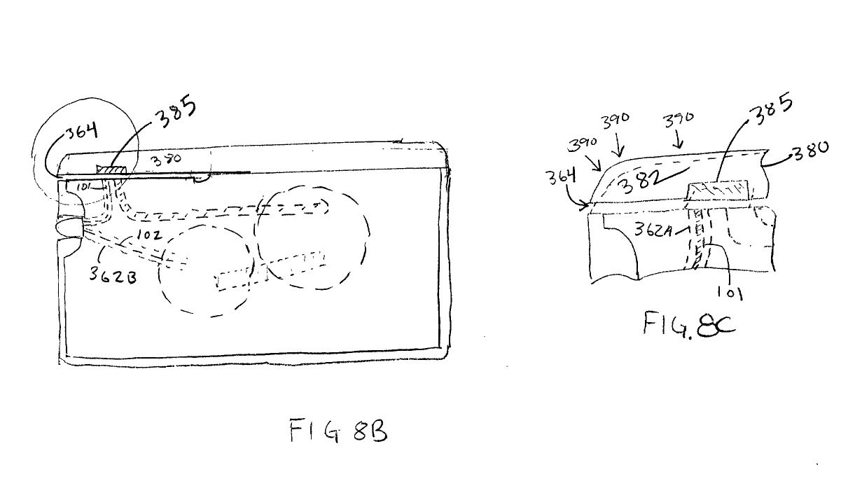

In the embodiment of the flat illuminator card light shown in FIGS. 8A-8C generally designated 350, a three part housing is illustrated device, with a central core 352A a top laminate 352B and a bottom laminate 352C. It will be understood by those skilled in the art that the top and/or bottom laminates may each also be constructed of more than one single laminate layer of material and such laminate layers may be combined to form the top and bottom laminates 352B & 352C. The central core 352A, top laminate 352B and or the bottom laminate 352C may be regular shapes (as shown) or an irregular, yet substantially planar, shape (not shown).

The central core 352A is a substantially planar semi-rigid part with a top laminate receiving inset 354, and a bottom laminate receiving inset (not shown) into which the top laminate 352B and a bottom laminate 352C mount by adhesive, pressure fit, sonic weld, glue, tape or any other suitable means.

The central core 352A has an LED mount 356 into which the light-emitting diode (LED) illumination source 100 with a first 101 and a second 102 lead wire is affixed, either by a pressure fit, adhesive, or a catch. A first and a second battery holster 358A & 358B, (each adapted to receive a stack of one or more batteries 200), and a first and second lead wire guide 362A & 362B.

When assembled, as shown in FIGS. 8B & 8C, the first lead wire 101 rests within the first lead wire guide 362A, which traverses from the LED mount 356 to the switch channel 364 and the second lead wire 102 rests above the first battery holster 358B within the second LED lead wire guide 362B. A first stack of batteries 200, is placed in the first battery holster 358A, with a positive terminal located on top (and a negative terminal on the bottom) in conductive contact with the second lead wire 102. Within the second battery holster 358B is placed a second stack of batteries 200 with a positive terminal on its bottom and second negative terminal on its top.

On the inside surface of the bottom laminate 370 a battery to battery contact 372 is formed. The battery to battery contact 372 may be a metal, a foil, or a conductive-type ink. The battery to battery contact 372 is positioned to connect the negative terminal on the bottom of one battery stack with the second positive terminal on the bottom of the other battery stack thus connecting the two battery stacks in series.

To allow for the connection of the LED 100 to the battery stacks a battery to LED contact 375 is affixed to the inner surface of the top laminate 352B and positioned to rest on top negative terminal of the second battery stack 200 and to terminate abutting the switch channel 364. A movable switching arm 380 extends along one edge of the central core 352B. The switching arm 380 has a free end 382 and a conductive switch contact 385 formed thereon. To complete the circuit and supply voltage to the LED pressure is applied to the movable switching arm 380 along the line of arrows 390 which causes the switching arms free end 382 to momentarily cross the switching channel 364 and place the conductive switch contact 385 across the first LED lead wire 101 and the battery to LED contact 375 to supply the voltage to the LED. Releasing the switching arm 380 interrupts the circuit.

Promotional material 384 & 386 may be affixed to, or printed on, the top and or bottom laminates 352B & 352C. A non-exhaustive list of suitable construction materials for the top and or bottom laminates 352B & 352C include, but are not limited to, labels, tape, coated paper, plastic, rubberized plastic, silicone, rubber, impregnated paper, polypropylene, vinyl, polyethylene, ABS, styrene, polycarbonate, laminated paper, and Mylar. The laminates may be clear, opaque, solid, flat, textured or patterned. Clear and or opaque laminates support placement of promotional material on the inside surface 370 which can be seen through the clear or opaque laminate.

To maintain a very thin profile the thickness of the device 350 need no greater than about the thickness of the selected LED 100. LED guide slots 388 may be formed in the top and bottom laminates to maintain minimum thickness.

Since certain changes may be made in the above apparatus without departing from the scope of the invention herein involved, it is intended that all matter contained in the above description, as shown in the accompanying drawing, the specification, and the claims shall be interpreted in an illustrative, and not a limiting sense.

We claim:

1. A flat illuminator with a flexible switching arm comprising:
a flat substantially plastic body;
a light emitting diode illumination source affixed to the plastic body;
a flexible switching arm, with a free end, extended from the plastic body;
a battery power supply mounted within the plastic body; and,
a conductive switch contact on the switching arm, whereby displacement of the switching arm in plane with the plastic body connects the battery power supply to the illumination source.

2. The flat illuminator of claim 1 in which the battery is a single lithium button battery.

3. The flat illuminator of claim 1 further comprising a resistor affixed between said lithium battery and the light emitting diode illumination source.

4. The flat illuminator of claim 1 in which the battery power supply is two or more lithium button batteries connected in series with a total voltage between 6 and 48 volts.

5. The flat illuminator of claim 1 in wherein the wavelength of the light emitted by the illumination source is substantially within one color of the visible spectral region.

6. The flat illuminator of claim 1 in wherein the wavelength of light emitted by the illumination source is substantially in the blue spectral region.

7. The flat illuminator of claim 1 further comprising a lens formed integrally as part of at least one of the light emitting diodes of the illumination source.

8. A multi-layered flat illuminator with flexible switching arm comprising:
a flat central core;
a light emitting diode illumination source affixed to the central core;
a flexible switching arm, with a free end, extended from the central core;
a battery power supply mounted within the central core;
a conductive switch contact on the switching arm whereby displacement of the switching arm in plane with the central core connects the battery power supply to the illumination source;
a top laminate affixed to the top of the central core; and,
a bottom laminate affixed to the bottom of the central core.

9. A multi-layered flat illuminator with flexible switching arm comprising:
a flat substantially planar central core;
a battery power supply mounted within the central core;
a movable on/off switching arm with a free end extended from the central core;
a switching channel formed between the switching arm and the central core;
a light emitting diode illumination source affixed to the substantially planar central core with a first and a second lead wire;
the first lead wire conductively linked to the battery power supply;
a battery to LED contact from the battery power supply to the switching channel;
a conductive switch contact on the switching arm, whereby displacement of the switching arm contacts the battery to LED contact and conductively links the battery power supply to the second lead wire;
a top laminate affixed to the top of the central core; and,
a bottom laminate affixed to the bottom of the central core.

10. The multi-layered flat illuminator card light of claim 9 wherein the laminates are constructed of materials selected from the group consisting of labels, tape, coated paper, plastic, rubberized plastic, silicone, rubber, impregnated paper, polypropylene, vinyl, polyethylene, ABS, styrene, polycarbonate, laminated paper, and Mylar.

11. The multi-layered flat illuminator card light of claim 9 wherein the battery to LED contact is constructed from a materials selected from the group consisting of metal, foil, and a conductive-type ink.

12. The multi-layered flat illuminator card light of claim 9 further comprising promotional material on the top and or bottom laminate.
